(19) United States
(12) Patent Application Publication
(10) Pub. No.: US 2011/0239377 A1
(43) Pub. Date: Oct. 6, 2011

(54) Heat Stable Fabric Softener

(76) Inventors: Renae Dianna Fossum, Middletown, OH (US); Jose Andres Rojo Moreno, Loveland, OH (US); Hugo Jean Marie Demeyere, Merchtem (BE); Kevin Lee Kott, Cincinnati, OH (US); Hans-Jurgen Kohle, Schluchtern (DE); Ulrike Kottke, Linsengericht (DE); Harald Jakob, Hasselroth (DE)

(21) Appl. No.: 12/752,209

(22) Filed: Apr. 1, 2010

(51) Int. Cl. C11D 3/30; C11D 3/43; C11D 3/60; D06L 1/20

(52) U.S. Cl. 8/137; 510/522; 510/525; 510/516

(57) ABSTRACT

Heat stable fabric softeners are particularly useful for use in developing markets.

### FIELD OF THE INVENTION

The present invention relates to fabric softeners.

### BACKGROUND OF THE INVENTION

Heat stability—particularly over the course of six months to a year or longer—is a problem for many fabric softener products. There is a need to extend the shelf life of these products to one year or longer, particularly where supply chains are less developed. This heat stability problem is particularly true for those markets that have high climate temperatures (e.g., greater than 35° C., or even 40° C.) and warehousing facilities that are not air conditioned. The problem is typically exacerbated in these markets given that distribution channels are such that consumer products may take months before they ultimately arrive on store shelves and even longer by the time consumers purchase and use the product. Therefore, there remains an unmet need for a fabric softener product that is heat stable over a long period of time (˜1 yr or even longer). Of course the fabric softener must meet these and other needs and still provide consumer-acceptable fabric softening.

There is continuing need for environmentally sustainable products. Generally, vegetable-based products are more preferred than animal-based products. There could be cultural reasons for this preference as well. There is a continuing need to identify fabric softening actives made from plant based oils. A further disadvantage of some animal sources of oils is that often distribution of oil components can vary with animal diet. This variability introduces manufacturing complexity and cost.

Fabric softener actives are typically quaternary ammonium compounds suitable for softening fabric in a rinse step. Fabric softener actives are typically cationically charged and bind to fabric during the rinse step. Examples include methyltriethanolammonium methylsulphate fatty acid diesters, and dimethyldiethanolammonium chloride fatty acid diesters. Fabric softener actives are biodegradable if made from a diester quaternary ammonium compound. Biodegradability is important for environmental reasons, but the ester functional group of these actives results in hydrolysis over time under aqueous conditions. Hydrolysis products such as monoester quaternary ammonium compound and fatty acid can destabilize the fabric softening product. Therefore many fabric softening products are formulated at around pH 3 since this is the optimum pH to minimize hydrolysis. However, such acidic conditions are not optimal for many adjunct ingredients. Rather, many of these adjunct ingredients are more stable closer to neutral pHs. But these less acidic pH ranges (e.g., pH 5-6) are not favorable for many of these fabric softening actives—particularly under high temperatures over time. Therefore there is a need for fabric softener products having a fabric softener active that has less pH sensitivity thereby allowing for greater formulation flexibility.

Fabric softening actives are reported to be heated to temperatures from about 60° C. to about 90° C. to form a fluidized melt. U.S. Pat. No. 4,789,491, col. 3, lines 48-49. These relatively high melting temperatures and high viscosities require high energy processing and specialized equipment to melt process these actives which may be cost prohibitive or capital intensive for developing markets. Even in developed markets, there is a continuing need to reduce energy and production costs in manufacturing. Therefore, there is a need for a lower melting fabric softening active and resulting lower viscosities.

There is also a continuing need to minimize the use of flammable solvents (e.g., ethanol and isoproponal). There may also be environmental concerns using high levels of these solvents. Of course the minimization of these solvents should ideally not come at the cost of storage stability.

Fabric softener viscosity is important to consumers. Although the exact viscosity is typically defined by regional preferences—generally if a product is too thin (i.e., not enough viscosity), the quality of the product may be called into question by the consumer. But if the product viscosity is too thick, the product may not have desirable pouring characteristics (i.e., too thick to pour out or adheres to the measuring device, etc.). Further complicating the ability to provide consumers the desired product viscosity consistently over the lifetime of the product stems from the fact that viscosity of the fabric softener product may change over time. Fabric softening products being subjected to high temperatures over time and having a low pH (e.g., pH <4) may exacerbate the product's viscosity growth over time (e.g., six months to one year or more) due to hydrolysis products such as monoester quaternary ammonium compound and fatty acid. Therefore, there is a need for a fabric softener product that maintains its viscosity over time—particularly under high temperatures and/or less acidic pH conditions.

U.S. Pat. No. 4,789,491; US 2006-0089293 A1; US 2009-0181877 A1; US 2007-0054835 A1; EP 0 293 955 A2; DE 24 30 140 C3; U.S. Pat. No. 6,653,275; WO 00/06678; DE 36 08 093 A1.

### SUMMARY OF THE INVENTION

The present invention attempts to meet one or more of these needs. A first aspect of the invention provides for a fabric softener product having a composition comprising from 1% to 49% a fabric softener composition comprising a compound of formula (I):

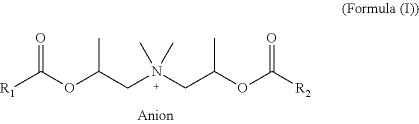

wherein R₁ and R₂ is each independently a C₁₅-C₁₇, and wherein the C₁₅-C₁₇ is unsaturated or saturated, branched or linear, substituted or unsubstituted.

Another aspect of the invention provides for a method of softening laundry comprising the step of administering an aforementioned composition, to a rinse cycle of an automatic laundry machine or a hand washing laundry rinse basin.

### BRIEF DESCRIPTION OF THE FIGURES

FIG. 1 is a schematic of a general method of making fabric softening actives of the present invention.

FIG. 2 is an HPLC analysis of the DEQ degradation component MEQ resulting from increasing the temperature of actives of the present invention, and those of commercialized actives.

FIGS. 3A and 3B is a fatty acid titration result which is a measurement of the hydrolysis of fabric softening actives made from commercialized cores and those actives of the present invention, respectively at various concentrations and at 50° C. over time.

FIG. 4 is a table summarizing HPLC results of DEQ degradation of fabric softening actives made from commercialized cores and those actives of present invention at 5% fabric softening active concentration at four weeks and twelve weeks at 40° C. and 50° C.

FIGS. 5, 6, and 7 report hydrolysis differences at pH 3 and pH 5 at different concentrations of fabric softening actives made from commercialized cores and those actives of present invention after aging at 21 days (and longer) at 50° C.

FIG. 8 is an expert panel assessing softness of fabric treated with an active of the present invention compared to a control.

FIG. 9 is a table of melt transition temperatures (Tm) and the end of melt temperatures of DEEDMAC and DIP QUAT 1.

FIG. 10 is a table of counter ion, iodine value (IV), melt transition temperature (Tm), end of melt temperature, and approximate distribution of fatty chains of actives of the present invention compared to DEEDMAC and DEEDMAMS.

FIG. 11 is an overlay of DSC curves of DIP QUAT 2, DIP QUAT 3, DIP QUAT 5, and DIP QUAT 7.

FIG. 12 is an overlay of DSC curves of DEEDMAC, DIP QUAT 1, DIP QUAT 4, and DIP QUAT 7.

FIG. 13 is an overlay of DSC curves of DIP QUAT 6, DIP QUAT 7, DIP QUAT 8, and DIP QUAT 9.

### DETAILED DESCRIPTION OF THE INVENTION

We have surprisingly discovered that using a fabric softening active of the following structure provides better heat stability over time than actives that are commercialized. Accordingly, one aspect of the invention provides for a fabric softener composition comprising compounds having formula (I):

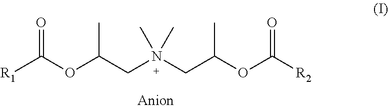

wherein R₁ and R₂ are each independently a C₁₅-C₁₉ (preferably C₁₅-C₁₇), and wherein the C₁₅-C₁₉ is unsaturated or saturated, branched or linear, substituted or unsubstituted (preferably linear and preferably unsubstituted). The anion is chosen from chloride or methylsulfate, preferably methylsulfate. The fabric softener composition of the present invention comprise from 1% to 49% of a fabric softener active. In one embodiment, the fabric softener composition of the invention comprises from 1% to 49% of a bis-(2-hydroxypropyl)-dimethylammonium methylsulphate fatty acid ester by weight of the composition. Preferably the compound of formula (I) exhibits desirable fabric softening benefits.

In one embodiment, R₁ and R₂ of formula (I) each independently have an average chain length of C₁₅, C₁₆, or C₁₇, preferably from 16.5 to 17.8 carbon atoms. The average chain length is calculated on the basis of the weight fraction of individual fatty acids in the mixture of fatty acids used to manufacture the fabric softening active. For branched chain fatty acids, the chain length refers to the longest consecutive chain of carbon atoms.

The Iodine Value (IV) of the actives suitable for use herein ranges from about 0.5 to about 60, preferably wherein the IV is from 15-50, alternatively from about 2 to about 50, or from about 20 to about 40, or from about 25 to about 40, or from about 15 to about 45, or from about 1 to about 60, or from about 18 to about 22, or combinations thereof. The Iodine Value is the amount of iodine in grams consumed by the reaction of the double bonds of 100 g of fatty acid, determined by the method of ISO 3961.

In one embodiment, each R₁ and R₂ is: C₁₅-C₁₉ fatty chain moiety with an IV value of 20 and an average chain length of 17.3 (“DIP QUAT 1), or C₁₋₇ saturated fatty chain moiety with an IV value of 0.7 and an average chain length of 17 (“DIP QUAT 2”).

In one aspect of the invention, the fabric softener composition further comprises a compound of formula (II):

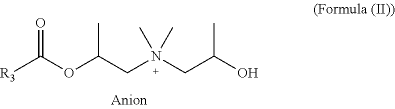

wherein R₃ is C₁₅-C₁₇ is unsaturated or saturated, branched or linear, substituted or unsubstituted (preferably linear and preferably unsubstituted); wherein the IV is from about 0.5 to 60, preferably wherein the IV from 15 to 50, alternatively from about 2 to about 50, or from about 20 to about 40, or from about 25 to about 40, or from about 15 to about 45, or from about 1 to about 60, or from about 18 to about 22, or combinations thereof. In one embodiment, the fabric softener composition of the invention comprises from about 0.1% to about 25%, alternatively from 0.2% to 10%, alternatively from 0.3% to 8% of compound of formula (II), alternatively combinations thereof. MEQ is an example of a compound of formula (II). DEQ is an example of a compound of formula (I).

In one embodiment, the bis-(2-hydroxypropyl)-dimethylammonium methylsulphate fatty acid ester is a mixture of at least one diester of formula (CH₃)₂N⁺(CH₂CH(CH₃)OC(═O)R)₂CH₃OSO₃⁻ and at least one monoester of formula (CH₃)₂N⁺(CH₂CH(CH₃)OH)(CH₂CH(CH₃)OC(═O)R)CH₃OSO₃⁻, where R is the hydrocarbon group of a fatty acid moiety RCOO. The bis-(2-hydroxypropyl)-dimethylammonium methylsulphate fatty acid ester has a molar ratio of fatty acid moieties to amine moieties of from 1.85 to 1.99. The specified molar ratio is desirable for simultaneously achieving high softening performance and low melt transition temperature(Tm) of the composition. If the molar ratio is lower than 1.85, the softening performance may be unsatisfactory.

The fatty acid moiety of the bis-(2-hydroxypropyl)-dimethylammonium methylsulphate fatty acid ester is derived from a mixture of fatty acids of formula RCOOH, where R is a hydrocarbon group. The hydrocarbon group may be branched or unbranched, substituted or unsubstituted, and preferably is unbranched and preferably unsubstituted.

To provide the required average chain length and iodine value, the fatty acid moiety is derived from a mixture of fatty acids comprising both saturated and unsaturated fatty acids. The unsaturated fatty acids are preferably monounsaturated fatty acids. The bis-(2-hydroxypropyl)-dimethylammonium methylsulphate fatty acid ester preferably comprises less than 6% by weight of multiply unsaturated fatty acid moieties. Examples of suitable saturated fatty acids are palmitic acid and stearic acid. Examples of suitable monounsaturated fatty acids are oleic acid and elaidic acid. In one embodiment, the cis/trans ratios of the double bond of unsaturated fatty acid moieties is from about 1:1 to about 5:1, or from about 1.2:1 to about 3.5:1, or from about 1.75:1 to about 3:1, or from 1.85:1 to about 3:1, or from 1.3:1 to 3.1:1, or combinations thereof, respectively.

The fraction of multiply unsaturated fatty acid moieties may be reduced by selective touch hydrogenation, which is a hydrogenation that selectively hydrogenates one double bond in a —CH═CH—CH₂—CH═CH— substructure but not double bonds of monounsaturated hydrocarbon groups. The specified average chain length and iodine values are essential for simultaneously achieving high softening performance and low Tm of the composition. If the average chain length is less than 16 carbon atoms or the iodine value is higher than 50, the softening performance will be unsatisfactory, whereas the Tm of the composition can get too high if the average chain length is more than 18 carbon atoms.

The fatty acid moiety may be derived from fatty acids of natural or synthetic origin and is preferably derived from fatty acids of natural origin, most preferably from fatty acids of plant origin. The required iodine value can be provided by using a fatty acid mixture of natural origin that already has such an iodine value, for example a tallow fatty acid. Alternatively, the required iodine value can be provided by partial hydrogenation of a fatty acid mixture or a triglyceride mixture having a higher iodine value. In a further and preferred embodiment, the required iodine value is provided by mixing a fatty acid mixture having a higher iodine value with a mixture of saturated fatty acids. The mixture of saturated fatty acids may be obtained either by hydrogenating a fatty acid mixture containing unsaturated fatty acids or from a hydrogenated triglyceride mixture, such as a hydrogenated vegetable oil.

In contrast to the actives of the present invention, DitallowoylEthanolEster DiMethyl Ammonium Chloride (hereinafter “DEEDMAC”) is found in commercial products; and DitallowoylEthanolEster DiMethyl Ammonium Methyl Sulfate (herein after “DEEDMAMS”) have a structure of:

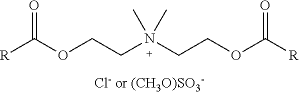

where “R” is “partially hardened” tallow having an IV of about 20. These actives have a methyl-diethanolamine core (or “common core”). DEEDMAC, for example, is an active in LENOR brand fabric softener sold in Western Europe. DEEDMAC and DEEDMAMS may be sourced from Evonik Industries.

Without wishing to be bound by theory, the high temperature stability of DIP QUAT 1 may be the result, at least in part, of the branched methyl groups next to the ester moiety (absent from DEEDMAC and DEEDMAMS) that may reduce hydrolysis by sterically hindering the reaction center and interfering with the transition state of the hydrolysis mechanism, and additionally shielding the esters from water (i.e., making the active more hydrophobic).

Furthermore, without wishing to be bound by theory, the reduction in melt transition temperature of the active below 60° C. may be the result of branching on the core and additionally the IV value of the fatty acid from about 0.5 to about 60.

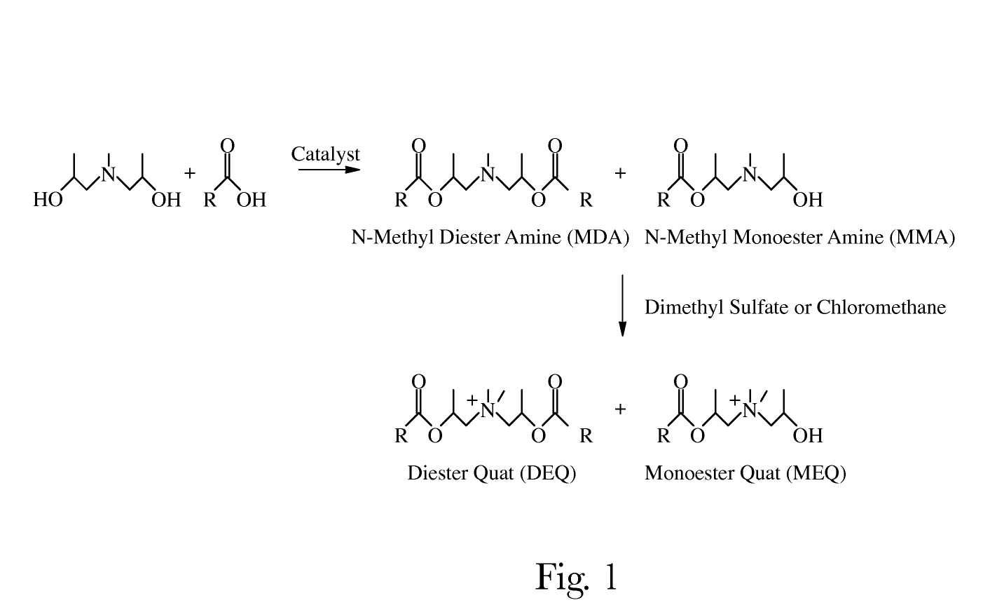

FIG. 1 shows a general method of making the DIP QUAT 1 of the present invention. In the first step, bis-(2-hydroxypropyl)-methylamine is combined with a fatty acid (having the desired fatty acid chain distribution and IV values) to form a mixture N-methyl diester amine (MDA) and N-methyl monoester amine (MMA). Of course any desired fatty acid may be used, including but not limited to fatty acids from vegetable sources with a fatty chain of C₁₆-C₂₀ with an IV from about 0.5 to about 60, preferably wherein the IV from 15 to 50, alternatively from about 2 to about 50, or from about 20 to about 40, or from about 25 to about 40, or from about 15 to about 45, or from about 1 to about 60, or from about 18 to about 22, or combinations thereof such as those derived from stearic, oleic, palmstearine, palmitic, partially hydrogenated palm, and other such sources. Thereafter, the MDA and MMA are quaternized with dimethyl sulfate or chloromethane. Dimethyl sulfate is preferred as a quaternization agent because it requires less time in a reactor (e.g., less than 1 day) than chloromethane to complete the quaternization reaction (e.g., several days and still may not go to completion). Furthermore, the quaternization reaction can be optionally performed using an optional solvent such as a low molecular weight alcohol (e.g., ethanol or isopropanol) and optionally a diluent (e.g., triglyceride) to yield the diester quaternary ammonium compound (DEQ) and monoester quaternary ammonium compound (MEQ).

In one embodiment, the triglyceride diluent is a fatty acid triglyceride having an average chain length of the fatty acid moieties of from 10 to 14 carbon atoms and an IV calculated for the free fatty acid, of from 0 to 15. In one embodiment, the fabric softening composition comprises from about 0.01% to 2%, alternatively from 0.1% to 1.5%, 0.2% to 1%, or combinations thereof, of a diluent by weight of the composition

In one embodiment, the fabric softener composition comprises at least one solvent selected from ethanol, propanol, isopropanol, n-propanol, n-butanol, t-butanol, glycerol, ethylene glycol, trimethylene glycol, tetramethylene glycol, pentamethylene glycol, hexamethylene glycol, diethylene glycol, triethylene glycol, propylene glycol, dipropylene glycol and C₁-C₄ alkyl monoethers of ethylene glycol, propylene glycol, and dipropylene glycol, sorbitol, alkane diols such as 1,2 propanediol, 1,3 propanediol, 2,3-butanediol, 1,4-butanediol, 1,3-butanediol, 1,5-pentanediol, and 1,6 hexanediol; phenylethyl alcohol, 2-methyl 1,3-propanediol, hexylene glycol, sorbitol, polyethylene glycols, 1,2-hexanediol, 1,2-pentanediol, 1,2-butanediol, 1,4-cyclohexanedimethanol, pinacol, 2,4-dimethyl-2,4-pentanediol, 2,2,4-trimethyl-1,3-pentanediol (and ethoxylates), 2-ethyl-1,3-hexanediol, phenoxyethanol (and ethoxylates), glycol ethers such as butyl carbitol and dipropylene glycol n-butyl ether or combinations thereof. In one embodiment, the fabric softening composition comprises from 0.01% to 25%, alternatively from about 0.01% to 10%, alternatively from 0.05% to 2.5%, alternatively from 0.1% to 5%, alternatively from 0.15% to 7.5%, or combinations thereof, of a solvent by weight of the composition.

Generally, from about 50 wt % to about 98 wt % of DEQ and from about 2% to about 50% MEQ is made. There may be some unreacted DMA and MMA also present (typically at about less than 1 wt %). It is the DEQ species that is thought to impart the significant portion of the softness feel to fabric. Therefore, it is desirable to maximize the amount of DEQ yield.

In one embodiment, the fabric softening composition comprises 1% to 49%, alternatively from 2% to 25%, alternatively from 3% to 20%, alternatively from 10% to 15%, alternatively from 4% to 7% of a fabric softening active, wherein the fabric softening active comprises both a compound of formula (I) (e.g., DEQ) and a compound of formula (II) (e.g., MEQ); wherein the ratio of formula (I) compound(s) to formula (II) compound(s) is from about 70:30 to 99:1, alternatively 80:20 to 90:10, alternatively 85:15 to 98:2, alternatively 90:10 to 95:5, alternatively combinations thereof, respectively.

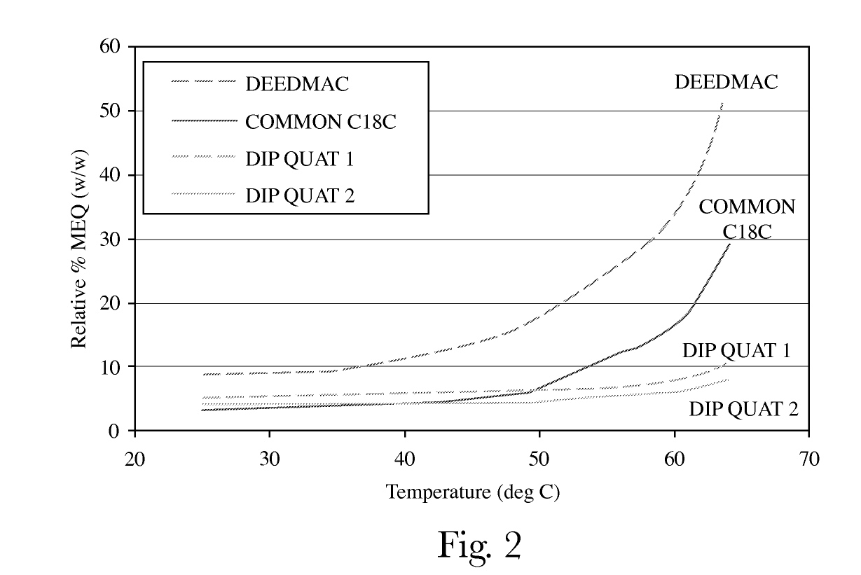

The fabric softening actives of the present invention, i.e., those having a DIP core, demonstrate greater heat stability over those actives having a common core in aqueous fabric softening dispersions. Heat stability is indirectly measured by the relative percentage of the MEQ that is released as a result of the hydrolysis of the DEQ species. High performance liquid chromatography (HPLC) is used to assess the percentage of MEQ relative to the total esterquat level (i.e., DEQ+MEQ) using purified DEQ and MEQ standards to calibrate. The HPLC results of samples that have been aged for 2 weeks over a temperature range from 25° C. to 65° C. are presented as FIG. 2.

Storage stability is determined for aqueous dispersions of the fabric softener active compositions that are stored at 50° C. in closed glass bottles. Dispersions are prepared by first dispersing a melt of the fabric softener active composition that is heated to 5 to 10° C. above the melt in a 0.05% by weight aqueous HCl solution that has been preheated preheated using an IKA Super-Dispax-Reactor® SD 41 operated at 8000 min⁻¹. Thereafter, a 25% by weight aqueous solution of CaCl₂ is added with stifling to provide a CaCl₂ concentration of 0.025% by weight. Acid values of the dispersions are determined before and after storage by acid-base-titration with KOH or NaOH and are given as mg KOH/g dispersion.

Turning to FIG. 2, as the temperature is increased from 25° C. to 65° C., DIP QUAT 1 and DIP QUAT 2 have only about 5% MEQ released relative to the total esterquat (i.e., starting from about 5% MEQ increasing to about 10% MEQ). In sharp contrast, the actives containing the common core, DEEDMAC and common C18C, have significantly increased amounts of relative MEQ above 40° C. The DEEDMAC has a starting level of about less than about 10% MEQ relative to total esterquat and the MEQ is increased to well over 50% MEQ after 2 weeks at 65° C. Similarly, a quaternary ammonium compound made from the common core and fully saturated stearic acid (common C18C) has a starting level of about 5% MEQ relative to total esterquat and similarly to DEEDMAC, the MEQ level in common C18C increases to nearly 30% MEQ after aging for 2 weeks at 65° C.

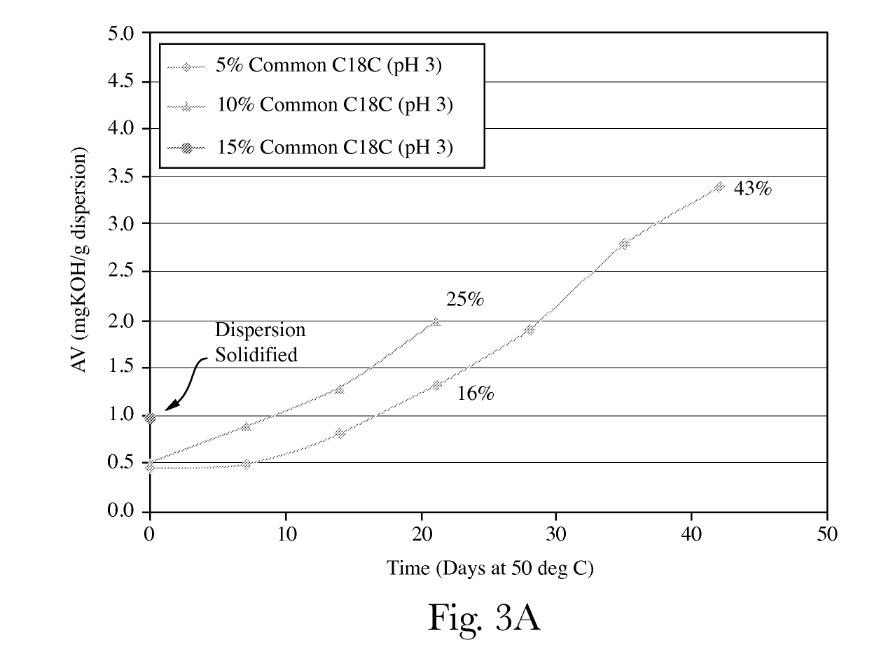

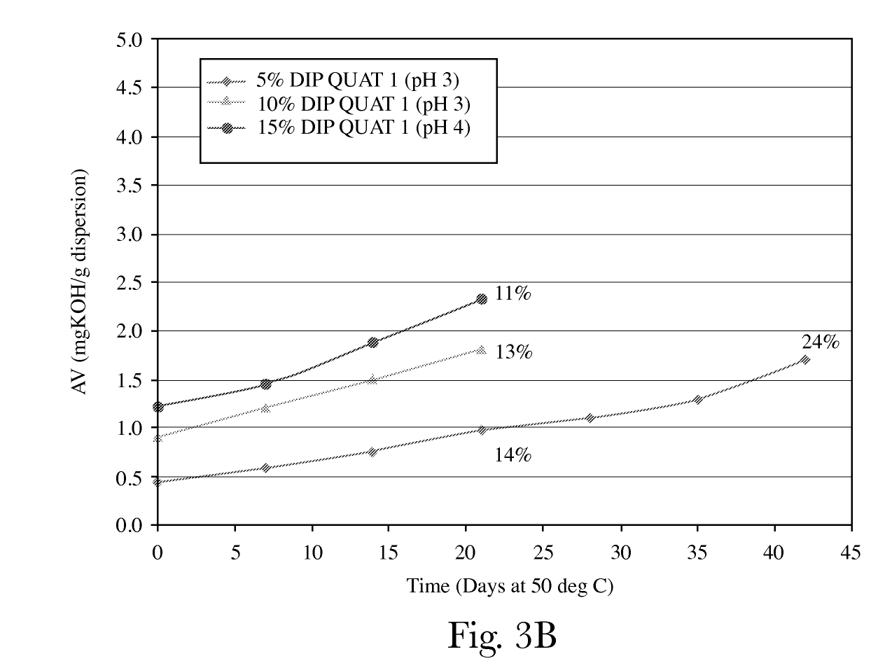

DIP QUAT 1 can be formulated from about 5% to about 20% and the viscosity remains reasonably low from exposures to high temperatures (˜50° C.) over a long period of time (˜20 or more days). Without wishing to be bound by theory, it is hydrolysis of the DEQ that leads to increases in viscosity. FIG. 3A and FIG. 3B is a comparison of hydrolysis as measured by the Fatty Acid Titration method of common-C18C and DIP QUAT 1 that have been formulated into aqueous dispersions that have been heated to 50° C. over time at different concentrations, respectively. FIG. 3A shows common-C18C at 5 wt %, 10 wt %, and 15 wt % concentrations. The 15% concentration is solidified after essentially the first day and thus further results are not available. The 10% concentration is hydrolyzed 25% at day 20. The 5% concentration is hydrolyzed 16% at day 20 and 43% at day 40. FIG. 3B shows DIP QUAT 1 has less hydrolysis compared to common-C18C at the comparative concentrations. The 15% concentration DIP QUAT 1 hydrolyzed 11% on day 20 (as compared to solidification of the 15% DEEDMAC). The 10% concentration is hydrolyzed 13% at day 20 which is an improvement of 12% less hydrolysis over common-C18C. The 5% concentration is hydrolyzed 14% at day 20 which is an improvement of 2% over common-C18C, and 24% at day 40 which is an improvement of 19% over common-C18C.

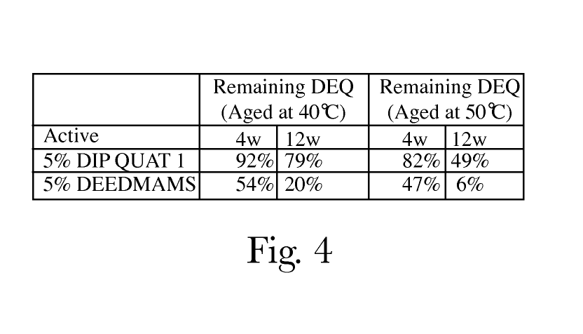

FIG. 4 is a table summarizing data from DIP QUAT 1 and DEEDMAMS that are exposed to elevated temperatures and the resulting degradation of the DEQ component. HPLC is used to assess the remaining DEQ component of the actives at 4 weeks (w) and 12 w at both 40° C. and at 50° C. DIP QUAT 1 degrades less than DEEDMAMS in all instances. In other words, there is more desirable DEQ component remaining in DIP QUAT 1 than DEEDMAMS after being exposed to these temperatures over 4 w and 12 w.

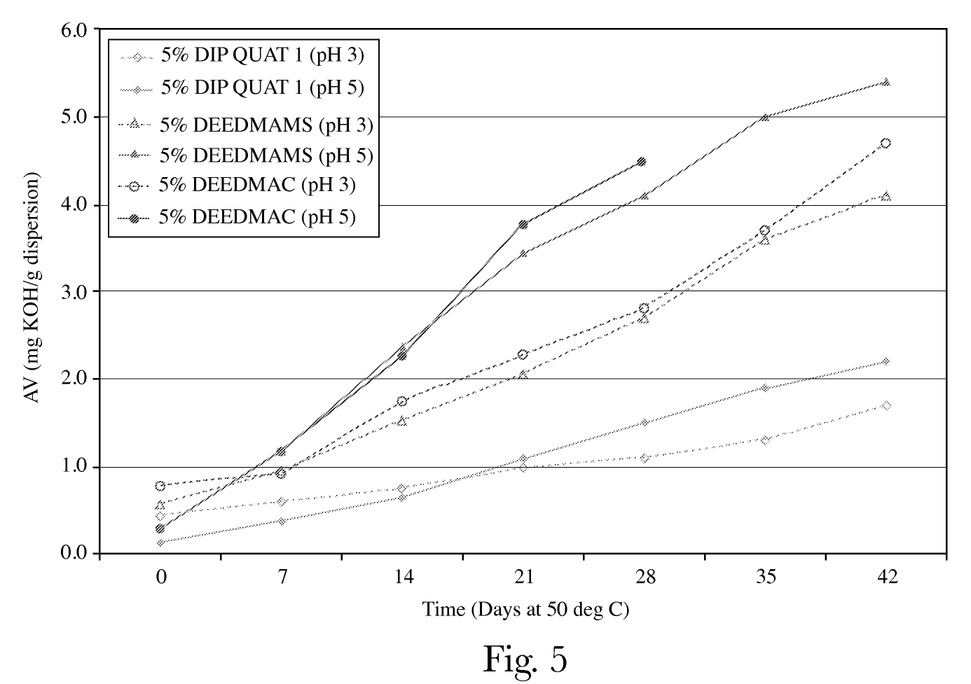

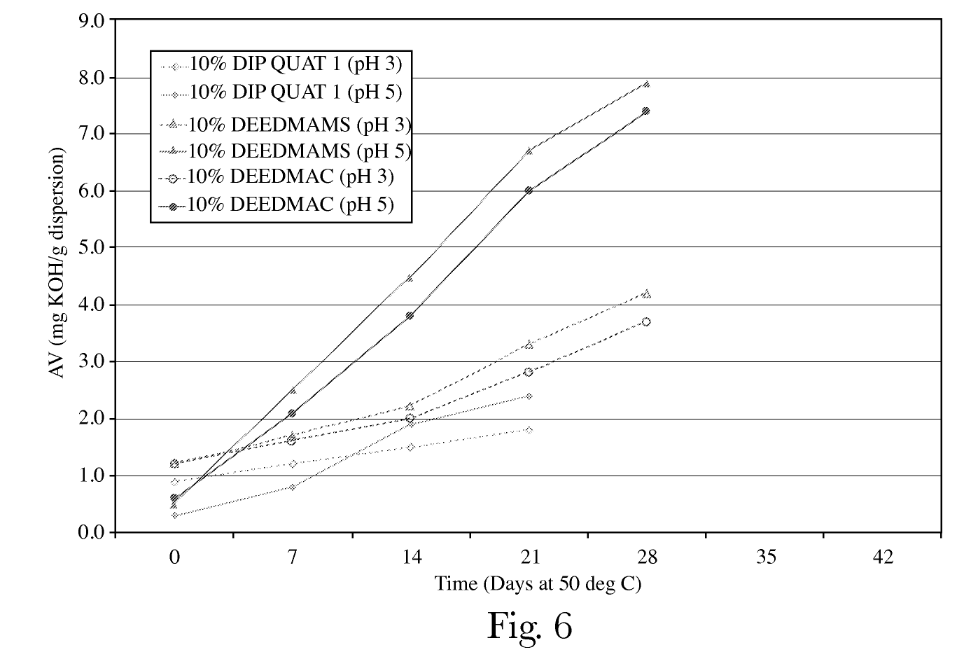

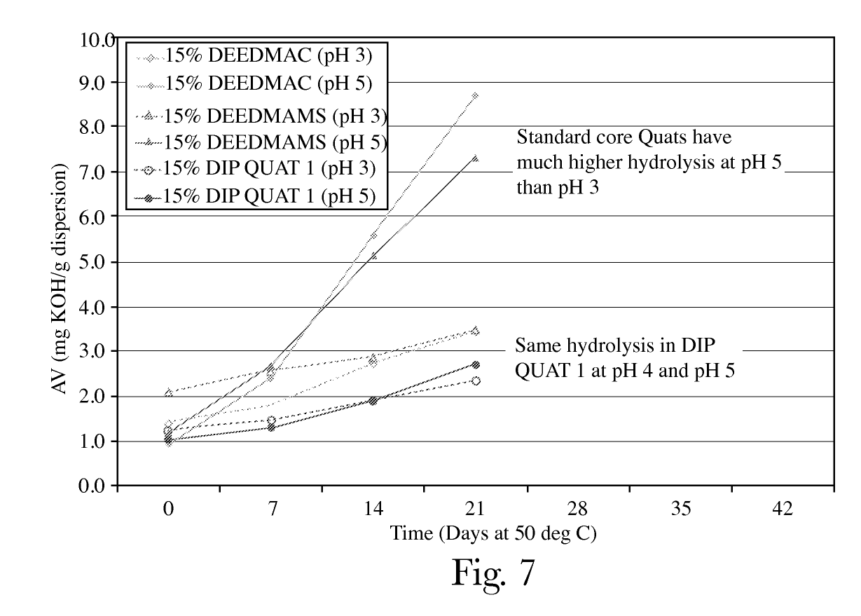

FIGS. 5, 6, and 7 demonstrate the increased hydrolytic stability of DIP QUAT 1 over DEEDMAMS and DEEDMAC at various concentrations (5%, 10%, and 15%, respectively) and pH ranges. DIP QUAT 1 has less hydrolysis than DEEDMAMS and DEEDMAC at pH 3 and pH 5 after 21 days or more at 50° C. DIP QUAT 1 does not show significant difference in hydrolysis from pH 5 to pH 3 at 5 and 10% concentrations, or from pH 4 to pH 5 at 15% concentration. The data therefore suggests that DIP QUAT 1 is less pH sensitive than DEEDMAMS and DEEDMAC.

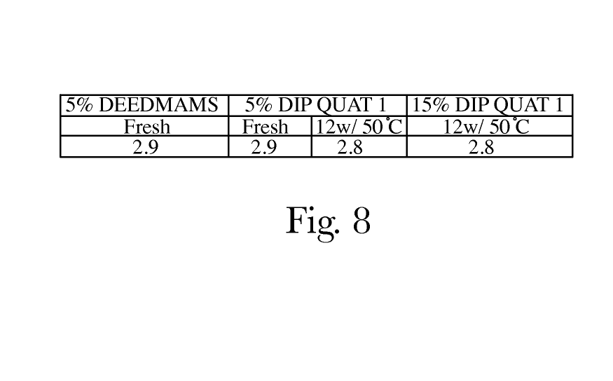

FIG. 8 demonstrates that DIP QUAT 1 delivers fabric softening feel. The treated fabrics are compared in an expert panel and the difference in softness relative to control is judged by expert graders. Results are expressed using the standard Panel Score Unit (“PSU”) scale: +4 PSU (very large difference in favor of TEST product) to −4 PSU (very large difference in favor of CONTROL product). The tests are blind. Fabrics that have not been treated with fabric softener are used as the control. Fabrics treated with fresh DIP QUAT 1 have the same PSU grade as fabrics treated with DEEDMAMS. Fabrics treated with DIP QUAT 1 dispersions at 5 and 15% concentration that have been aged for 12 weeks at 50° C. have almost the same PSU values as fabrics treated with fresh DIP QUAT 1 and DEEDMAMS.

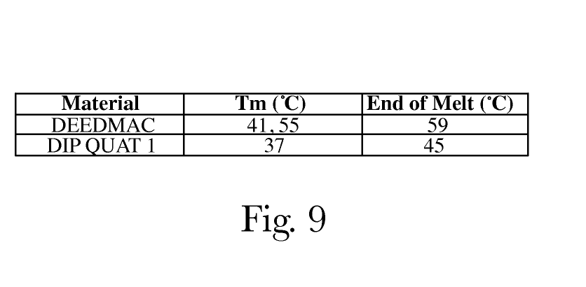

FIG. 9 is directed to the melt transition temperature, Tm, and end of melt temperature decrease that is observed between the common core and DIP core as measured from the second cycle of the Differential Scanning calorimetry (DSC) curve. Without wishing to be bound by theory, a fabric softening active with a lower melt transition and lower end of melt will require less energy to convert into a fabric softening composition, resulting in lower production costs for manufacturing the fabric softening active into a fabric softener composition. Furthermore, a lower melt transition temperature may enable elimination of the solvent used to lower the melting point and melt viscosity of the fabric softening active, and may be processed using less sophisticated capital for melting the active (e.g. low pressure steam heating, or even warm water to melt the fabric softening active in a tote or isotainer).

In the DSC measurement, thermal properties of samples are analyzed with a Differential Scanning calorimeter (DSC) Q1000 (V9.8) from TA Instruments Thermal Analysis with a Q2000 DSC cell and a liquid nitrogen cooling system. A nitrogen purge of 50 mL/min is applied to the sample cell. The instrument temperature and cell constant calibration is performed on indium metal provided by TA instruments at a heating rate of 10° C./min. Indium metal is run as a validation of the calibration, verifying the onset of the melt and the heat of the melt (area of the curve). The baseline is calibrated from −50° C. to 300° C. at a heating rate of 10° C./min using sapphire. Samples are contained in hermetically sealed pans to prevent loss of volatile components during heating. Samples are cooled to −60° C. and held at −60° C. for 1 minute. The samples are then heated at 10° C./min to 80° C. and held at 80° C. for 1 minute. Samples are then cooled at 10° C./min to −60° C. and held at −60° C. for 1 minute. Finally, samples are heated for a second cycle at 10° C./min to 80° C. The maximum change in heat flow of the endothermic peak in the second heating cycle is reported to characterize the melt transition temperature. The end of melt is reported as the temperature at which the heat flow returns to baseline from the second heating cycle.

FIG. 9 shows that the DEEDMAC has a melt transition with maxima at 41 and 55° C. with an end of melt at 59° C., and DIP QUAT 1 has a melt transition of 37° C. and an end of melt temperature at 45° C. which is 14° C. lower than the DEEDMAC.

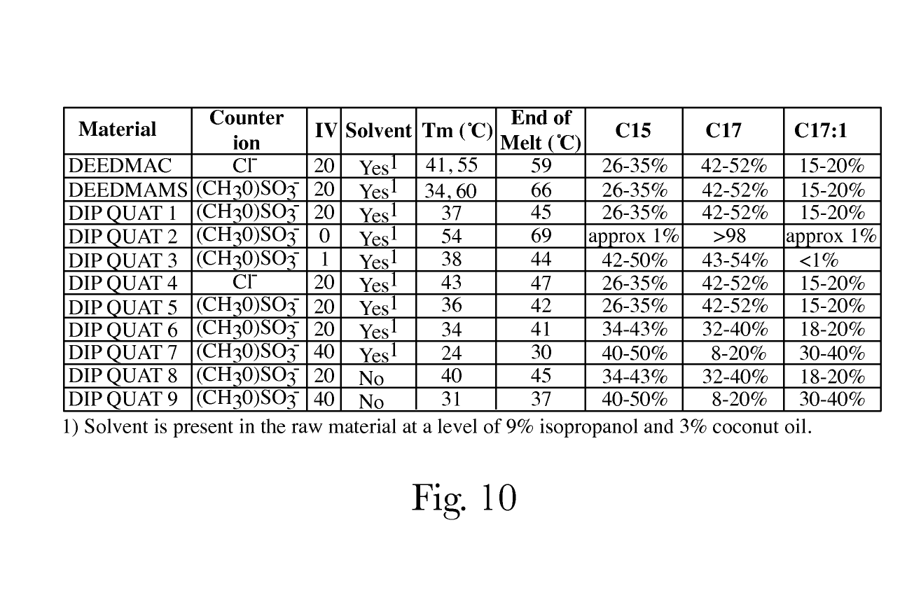

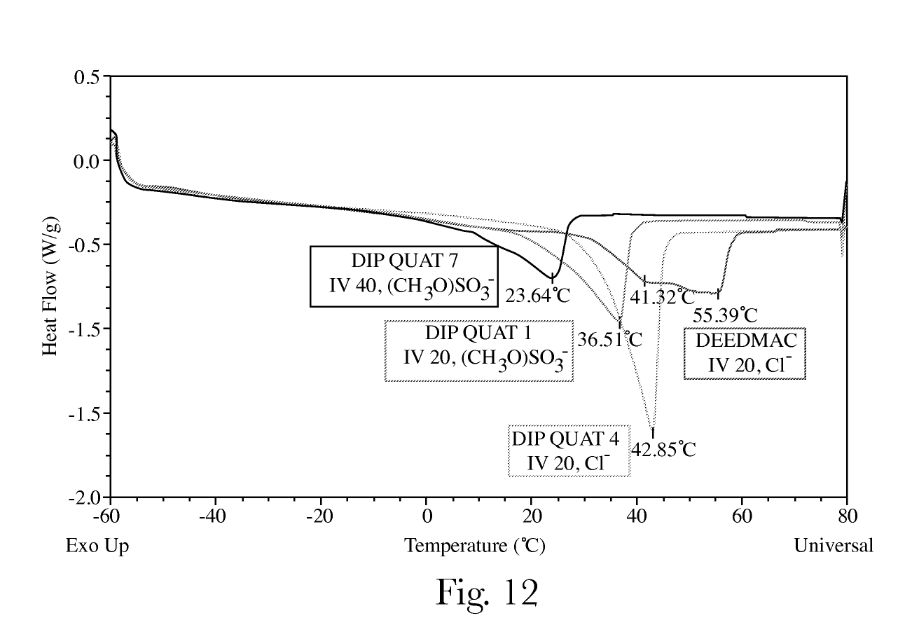

FIG. 10 is directed to the Tm and the end of melt differences in DIP QUAT materials with different counter ions, IV values, and fatty chain distributions. The difference in Tm with counter ion can be seen between DIP QUAT 1 and DIP QUAT 4 where the chloride counter ion has a Tm that is 6° C. higher than the methyl sulfate counter ion (see also FIG. 12). Furthermore, the Tm of the DIP QUAT materials is influenced by the level of unsaturation (or IV value) of the fatty chain where the more saturated fatty chains with lower IV values have higher Tm. For example, DIP QUAT 2 is made from stearic acid, having an IV of 0.7, and has a Tm of 54° C., whereas DIP QUAT 7 made from partially hydrogenated palmitic acid with an IV of 40 and has a Tm of 24° C. (a decrease of 30° C.). The DIP QUAT 2 and DIP QUAT 3 have the same approximate level of unsaturation (0-1% C17:1), however the DIP QUAT 3 has a higher level of nor C15 in the fatty chain (25-35% versus ˜1%, respectively) and has a Tm of 38° C. (a decrease of 16° C. versus DIP QUAT 2).

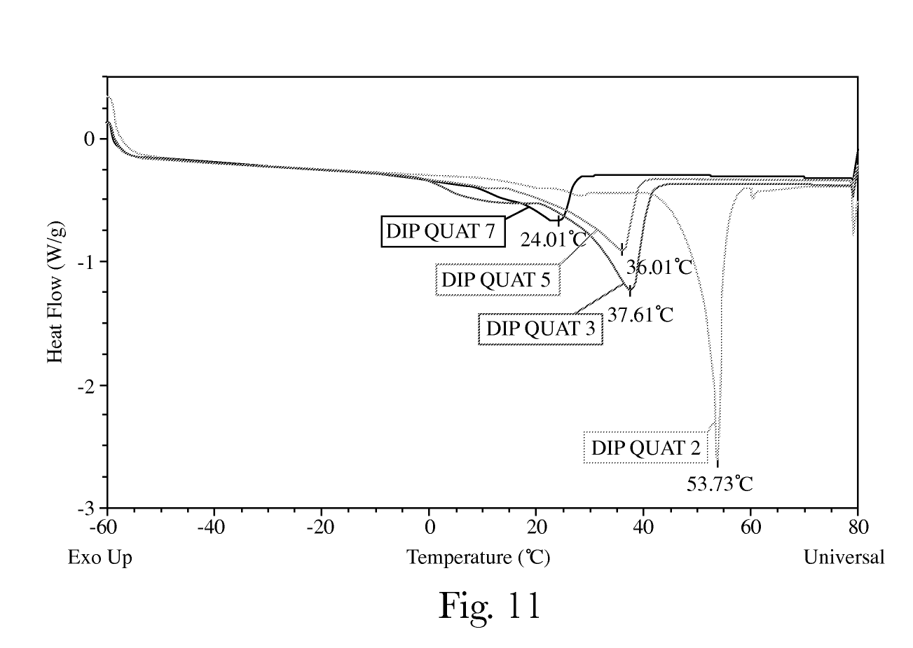

FIG. 11 is an overlay of the DSC curves of DIP QUAT 2, DIP QUAT 3, DIP QUAT 5, and DIP QUAT 7 that shows the decrease in melting behavior by increasing the IV from 1 to 20 to 40, respectively, and varying the average chain length.

FIG. 12 is an overlay of the DSC curves of DEEDMAC, DIP QUAT 1, DIP QUAT 4, and DIP QUAT 7, that shows the decrease in melting behavior by changing the core, the counter ion and the fatty chain. The melt transition for DEEDMAC with maxima at 41 and 55° C. is decreased to 43° C. for DIP QUAT 4 by introducing branching on the core (same fatty chain and same counter ion). The Tm is decreased from 43° C. in DIP QUAT 4 to 37° C. in DIP QUAT 1 by changing the counter ion from chloride to methyl sulfate, respectively. The Tm is decreased from 37° C. in DIP QUAT 1 to 24° C. in DIP QUAT 7 by increasing IV value of the fatty chain (IV 20 in DIP QUAT 1 and IV 40 in DIP QUAT 7).

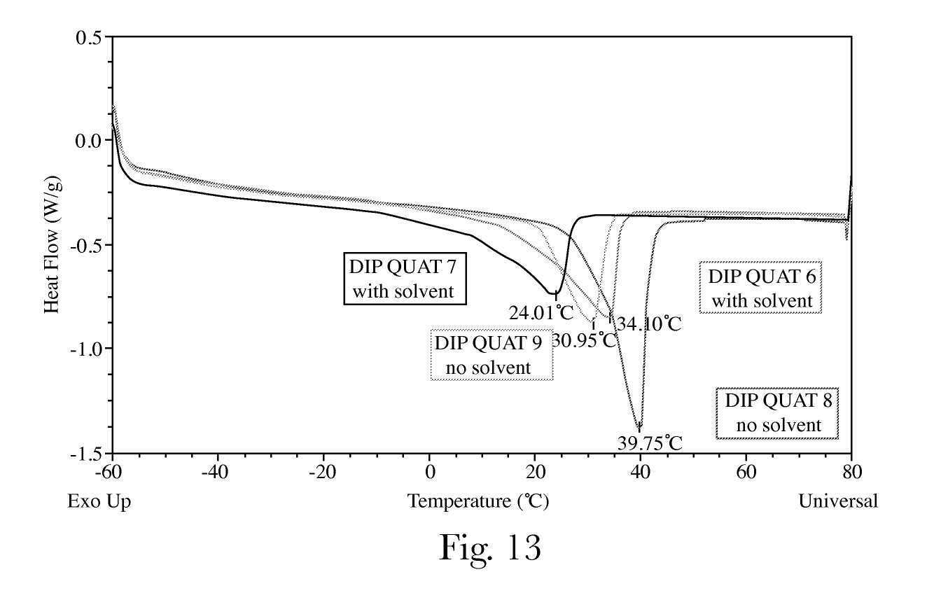

FIG. 13 is an overlay of DSC curves of DIP QUAT 6, DIP QUAT 7, DIP QUAT 8, and DIP QUAT 9 that shows the increase in melting behavior by not including the solvent and diluent. The Tm of DIP QUAT 6 increases from 34° C. to 40° C. in DIP QUAT 8 when the solvent is not included, and the Tm of the DIP QUAT 7 increases from 24° C. to 31° C. in DIP QUAT 9 when the solvent is not included. In one embodiment, the fabric softening active has a melt transition temperature below 55° C., alternatively below 53° C., 50° C., 45° C., 40° C., 37° C., 36° C., 35° C., 33° C., 32° C., 31° C., 30° C., 25° C., 23° C., 22° C., or below 21° C. In another embodiment, the melt transition temperature is from 55° C. to 15° C. In another embodiment, the melt transition temperature is from 40° C. to 15° C.

In another embodiment, the fatty acid distribution of the starting materials used to make the quaternary ammonium compounds is predominantly from C16 to C18 with unsaturation levels varying from <1% to 50%. The composition of C16 is from about 1% to 65%, alternatively 20% to 45%, alternatively from about 25% to 50%. The composition of C18 is from about 5% to 99%, alternatively from about 20% to 60%, alternatively from about 30% to 60%, alternatively from about 35% to 55%. The composition of C18 with one unsaturated bond is from about 0 to about 50%, alternatively from about 10% to about 40%, alternatively from about 15% to about 30%, alternatively from about 15% to about 20%. The ratio of C15:C17:C17:1 in the fabric softening active is from about 1:98:1 to 50:49:1, alternatively from about 1:98:1 to 6.25:1:3.75, alternatively from about 1.3:2.7:1 to 6.25:1:1.5, alternatively from about 1.7:2.6:1 to 50:49:1, alternatively from about 2:1:1.5 to about 1:98:1

These fabric softeners typically have about 1% to about 49%, alternatively from about 2% to about 25%, alternatively from about 3% to about 20%, alternatively from about 5% to about 17%, alternatively combinations thereof, of a fabric softening active by weight of the composition.

One aspect of the invention provides fabric softening composition comprising cationic polymers for aiding in depositions and/or rheology benefits. See e.g., U.S. Pat. No. 6,492,322 B1; US 2006-0094639. In one embodiment, the composition comprises from about 0.1% to about 5%, preferably from 0.7% to 2.5%, by weight of a cationic cross-linked polymer that is desirable from the polymerization of from 5 to 100 mole present of cationic vinyl addition monomer, from 0 to 95 mole percent of acrylamide and from 50 to 1000 parts per million (ppm), preferably 350 to 100 ppm, more preferably 500 to 1000 ppm of a vinyl addition monomer cross-linking agent. An example of such polymer may include Rheovis CDE from Ciba (BASF).

### Adjunct Ingredients

Adjunct ingredients that may be added to the compositions of the present invention. The ingredients may include: suds suppressor, preferably a silicone suds suppressor (US 2003/0060390 A1, å65-77), cationic starches (US 2004/0204337 A1; US 2007/0219111 A1); scum dispersants (US 2003/0126282 A1, å89-90); perfume and perfume microcapsules (U.S. Pat. No. 5,137,646); nonionic surfactant, non-aqueous solvent, fatty acid, dye, preservatives, optical brighteners, antifoam agents, and combinations thereof.

Other adjunct ingredients may include: dispersing agent, stabilizer, pH control agent, metal ion control agent, colorant, brightener, dye, odor control agent, pro-perfume, cyclodextrin, solvent, soil release polymer, preservative, antimicrobial agent, chlorine scavenger, enzyme, anti-shrinkage agent, fabric crisping agent, spotting agent, anti-oxidant, anti-corrosion agent, bodying agent, drape and form control agent, smoothness agent, static control agent, wrinkle control agent, sanitization agent, disinfecting agent, germ control agent, mold control agent, mildew control agent, antiviral agent, anti-microbial, drying agent, stain resistance agent, soil release agent, malodor control agent, fabric refreshing agent, chlorine bleach odor control agent, dye fixative, dye transfer inhibitor, color maintenance agent, color restoration/rejuvenation agent, anti-fading agent, whiteness enhancer, anti-abrasion agent, wear resistance agent, fabric integrity agent, anti-wear agent, and rinse aid, UV protection agent, sun fade inhibitor, insect repellent, anti-allergenic agent, enzyme, flame retardant, water proofing agent, fabric comfort agent, water conditioning agent, shrinkage resistance agent, stretch resistance agent, enzymes, cationic starch, and combinations thereof. In one embodiment, the composition comprises one or more adjunct ingredient up to about 2% by weight of the composition. In yet another embodiment, the composition of the present invention may be free or essentially free of any one or more adjunct ingredients. In yet another embodiment, the composition is free or essentially free of detersive laundry surfactants.

In one embodiment, the pH of the composition may comprise a pH of from about 2 to about 5, preferably from about 2 to about 4.5, and more preferably from about 2.5 to about 4. In another embodiment, the composition comprises a neutral pH, alternatively from about 5 to about 9, alternatively from 5.1 to about 6, alternatively from about 6 to about 8, alternatively from about 7, alternatively combinations thereof.

In one embodiment, the composition of the present invention further comprises a perfume microcapsule. Suitable perfume microcapsules may include those described in the following references: US 2003-215417 A1; US 2003-216488 A1; US 2003-158344 A1; US 2003-165692 A1; US 2004-071742 A1; US 2004-071746 A1; US 2004-072719 A1; US 2004-072720 A1; EP 1393706 A1; US 2003-203829 A1; US 2003-195133 A1; US 2004-087477 A1; US 2004-0106536 A1; U.S. Pat. No. 6,645,479; U.S. Pat. No. 6,200,949; U.S. Pat. No. 4,882,220; U.S. Pat. No. 4,917,920; U.S. Pat. No. 4,514,461; U.S. Pat. No. RE 32713; U.S. Pat. No. 4,234,627. In another embodiment, the perfume microcapsule comprises a friable microcapsule (e.g., aminoplast copolymer comprising perfume microcapsule, esp. melamine-formaldehyde or urea-formaldehyde). In another embodiment, the perfume microcapsule comprises a moisture-activated microcapsule (e.g., cyclodextrin comprising perfume microcapsule). In another embodiment, the perfume microcapsule may be coated with a polymer (alternatively a charged polymer). US published patent application claiming priority to U.S. Provisional Application Ser. No. 61/258,900, filed Nov. 6, 2009.

In one aspect of the invention, a method of softening or treating a fabric is provided. In one embodiment, the method comprises the step of obtaining a composition of the present invention. In another embodiment, the method comprises the step of administering a composition of the present invention to a rinse cycle of an automatic laundry machine or a hand washing laundry rinse basin. The term “administering” means causing the composition to be delivered to a rinse bath solution. Examples of administering include, for example, dispensing the composition in an automatic fabric softener dispenser that is integral to the laundry washing machine whereby the dispenser dispenses the composition at the appropriate time during the laundry washing process, e.g., last rinse cycle. Another example is dispensing the composition in a device, such a DOWNY BALL, wherein the device will dispense the composition at the appropriate time during the laundry washing process. In another embodiment, a composition of the present invention is dosed in a first rinse bath solution or a dosed in a single rinse bath solution. This is particularly convenient in a hand washing context. See e.g., U.S. Pat. Appl. No. 2003-0060390 A1. In one embodiment, a method of softening a fabric in a manual rinse processes comprising the steps: (a) adding a fabric softening composition of the present invention to a first rinse bath solution; (b) rinsing manually the fabric in the first rinse bath solution; (c) optionally the fabric softening composition comprises a suds suppressor. A method of reducing the volume of water consumed in a manual rinse process comprises the aforementioned step is also provided.

### Method of Making the Active

The fabric softener active of the present invention may be prepared by the method comprising the steps of reacting bis-(2-hydroxypropyl)-methylamine with a fatty acid having an average chain length of from 16 to 18 carbon atoms and an iodine value of from 0.5 to 50 in a molar ratio of fatty acid to amine of from 1.86 to 2.1 with removal of water until the acid value of the reaction mixture is in the range from 1 to 10 mg KOH/g and further reacting with dimethylsulphate at a molar ratio of dimethylsulphate to amine of from 0.90 to 0.97 and preferably from 0.92 to 0.95 until the total amine value of the reaction mixture is in the range from 1 to 8 mg KOH/g.

In the first step of the method of the invention, bis-(2-hydroxypropyl)-methylamine is reacted with the fatty acid in a molar ratio of fatty acid to amine of from 1.86 to 2.1 with removal of water. The reaction is preferably carried out at a temperature of from 160 to 220° C. Water is preferably removed by distillation from the reaction mixture. During the course of the reaction, the pressure is preferably reduced from ambient pressure to a pressure in the range from 100 to 5 mbar to enhance the removal of water. The first step may be carried out in the presence of an acidic catalyst, which is preferably used in an amount of from 0.05 to 0.2% by weight. Suitable acidic catalysts are methanesulfonic acid and p-toluenesulfonic acid. The reaction is carried out until the acid value of the reaction mixture is in the range from 1 to 10 mg KOH/g. The acid value is determined by titration with a standardised alkaline solution according to ISO 660 and is calculated as mg KOH per g sample. The reaction can then be stopped by cooling to a temperature below 80° C. in order to avoid further reaction of the fatty acid and maintain unreacted fatty acid to achieve the required amount of fatty acid in the final product.

In the second step of the method of the invention, the reaction mixture obtained in the first step is reacted with dimethylsulphate at a molar ratio of dimethylsulphate to amine of from 0.90 to 0.97 and preferably from 0.92 to 0.95. The reaction is preferably carried out at a temperature of from 60 to 100° C. The reaction is carried out until the total amine value of the reaction mixture is in the range from 1 to 8 mg KOH/g. The total amine value is determined by non-aqueous titration with perchloric acid according to method Tf 2a-64 of the American Oil Chemists Society and is calculated as mg KOH per g sample.

The method of the invention has the advantage of providing a fabric softener active composition according to the invention without requiring any step in addition to the steps needed for manufacturing the bis-(2-hydroxypropyl)-dimethylammonium methylsulphate fatty acid ester. This advantage is achieved by the appropriate choice of the molar ratio of fatty acid to amine and by carrying out the reaction of fatty acid and amine to the specified range of the acid value, maintaining a fraction of unreacted fatty acid.

### EXAMPLES

The following are non-limiting examples of making the fabric softening active useful in a fabric softener composition. Contents of free amine, amine salt and fatty acid in the fabric softener active composition are determined by non-aqueous potentiometric titration with tetrabutylammonium hydroxide after addition of an excess of a solution of HCl in 2-propanol fractions of monoester and diester in the bis-(2-hydroxypropyl)-dimethylammonium methylsulphate fatty acid ester are determined by HPLC (Waters Spherisorb® SCX column, methanol eluent with a formic acid triethylamine buffer, RI detection).

### Example I

2168.4 g (7.94 mol) of partially hydrogenated tallow fatty acid with an IV 20 is placed in an electrically heated reactor equipped with a thermometer, a mechanical stirrer and a rectifying column and is esterified with 596 g (4.083 mol) bis-(2-hydroxypropyl)-methylamine by heating with stifling to 200° C. and is kept at this temperature for 4 h at ambient pressure, distilling off water through the rectifying column. The pressure is then reduced to 10 mbar and the mixture is further stirred for 7 h at 200° C., and water is removed with a vacuum pump until the acid value of the reaction mixture is 5.6 mg KOH/g. The resulting mixture is then cooled to 75° C., 106 g of coconut oil is charged and 489 g (3.87 mol) dimethylsulphate is added and the resulting mixture is stirred for 2 h at 75° C. 318 g of isopropyl alcohol is added and the reaction mixture homogenized. The resulting fabric softener active composition is a white solid, containing 0.066 mmol/g (1.8% by weight) fatty acid and 0.108 mmol/g non-quaternised amine (0.058 mmol/g free amine and 0.050 mmol/g protonated amine). HPLC analysis shows the bis-(2-hydroxypropyl)-dimethylammonium methylsulphate fatty acid ester to be comprised of 6.1% monoester and 93.1% diester (rel. area percentages).

Example II is made using a similar procedure as Example I:

1596.7 g (5.83 mol) of partially hydrogenated vegetable fatty acid with an IV 19.5 is esterified with 436.9 g (2.99 mol) bis-(2-hydroxypropyl)-methylamine with 5 h reaction at ambient pressure and 5 h reaction at reduced pressure until the acid value of the reaction mixture is 3.8 mg KOH/g. The resulting mixture is charged with 78 g coconut oil and is reacted with 358 g (2.84 mol) dimethylsulphate. 234.1 g isopropyl alcohol is added. The resulting fabric softener active composition is a white solid containing 0.053 mmol/g (1.4% by weight) fatty acid and 0.103 mmol/g non-quaternised amine (0.061 mmol/g free amine and 0.042 mmol/g protonated amine). HPLC analysis shows the bis-(2-hydroxypropyl)-dimethylammonium methylsulphate fatty acid ester to be comprised of 4.0% monoester and 96.0% diester (rel. area percentages).

Example III is made using a similar procedure as Example I:

1910.8 g (7.04 mol) of partially hydrogenated vegetable fatty acid blend with an IV 19 is esterified with 525.6 g (3.60 mol) bis-(2-hydroxypropyl)-methylamine with 5 h reaction at ambient pressure and 5 h reaction at reduced pressure until the acid value of the reaction mixture is 5.8 mg KOH/g. The resulting mixture is reacted with 431 g (3.42 mol) dimethylsulphate. The resulting fabric softener active composition is a white solid containing 0.072 mmol/g (1.95% by weight) fatty acid and 0.114 mmol/g non-quaternised amine (0.059 mmol/g free amine and 0.055 mmol/g protonated amine). HPLC analysis shows the bis-(2-hydroxypropyl)-dimethylammonium methylsulphate fatty acid ester to be comprised of 8.0% monoester and 92.0% diester (rel. area percentages).

Example IV is made using a similar procedure as Example I:

1192.1 g (4.38 mol) of partially hydrogenated vegetable fatty acid with an IV 39 is esterified with 332.0 g (2.27 mol) bis-(2-hydroxypropyl)-methylamine with 5 h reaction at ambient pressure and 4 h reaction at reduced pressure until the acid value of the reaction mixture is 3.2 mg KOH/g. The resulting mixture is charged with 59 g coconut oil and is reacted with 272.4 g (2.16 mol) dimethylsulphate. 181.9 g isopropyl alcohol is added. The resulting fabric softener active composition is a white solid containing 0.049 mmol/g (1.3% by weight) fatty acid and 0.109 mmol/g non-quaternised amine (0.059 mmol/g free amine and 0.050 mmol/g protonated amine). HPLC analysis shows the bis-(2-hydroxypropyl)-dimethylammonium methylsulphate fatty acid ester to be comprised of 5.1% monoester and 94.9% diester (rel. area percentages).

Example V is made using a similar procedure as Example I:

2958.1 g (10.87 mol) of partially hydrogenated vegetable fatty acid with an IV 39 is esterified with 816.7 g (5.59 mol) bis-(2-hydroxypropyl)-methylamine with 5 h reaction at ambient pressure and 6 h reaction at reduced pressure until the acid value of the reaction mixture is 4.3 mg KOH/g. The resulting mixture is reacted with 670 g (5.31 mol) dimethylsulphate. The resulting fabric softener active composition is a white solid containing 0.055 mmol/g (1.5% by weight) fatty acid and 0.101 mmol/g non-quaternised amine (0.049 mmol/g free amine and 0.052 mmol/g protonated amine). HPLC analysis shows the bis-(2-hydroxypropyl)-dimethylammonium methylsulphate fatty acid ester to be comprised of 5.9% monoester and 94.1% diester (rel. area percentages).

### Examples

The following are non-limiting examples of the fabric care compositions of the present invention.

| | FORMULATION EXAMPLES | | | | | | | | |
|---|---|---|---|---|---|---|---|---|---|
| (% wt) | VI | VII | VIII | IX | X | XI | XII | XIII | XIV |
| FSA | 15^{a} | 12.25^{b} | 12.25^{b} | 12.25^{c} | 12.25^{d} | 5^{d} | 5^{a} | 17^{e} | 12.25^{e} |
| Isopropyl | 1.53 | 1.25 | 1.25 | — | 1.25 | 0.5 | 0.5 | — | — |
| Alcohol | | | | | | | | | |
| Ethanol | — | — | — | — | — | — | — | 1.75 | — |
| Coconut Oil | 0.51 | 0.42 | 0.42 | — | | 0.17 | 0.17 | 0.58 | — |
| Starch^{f} | — | — | — | — | — | — | — | 0.8 | — |
| Thickening | 0.15 | 0.01 | 0.15 | — | — | 0.01 | 0.01 | — | — |
| Agent^{g} | | | | | | | | | |
| Perfume | 0.5 | 4.0 | 2.4 | 4.0 | 3.5 | 1.5 | 0.5 | 1.25 | 4.0 |
| Perfume | — | — | — | — | 0.25 | — | — | 0.5 | — |
| Micro- | | | | | | | | | |
| capsules^{h} | | | | | | | | | |
| Calcium | 0.10 | 0.05 | — | 0.10 | 0.10 | — | — | 0.19 | 0.10 |
| Chloride | | | | | | | | | |
| DTPAⁱ | 0.05 | 0.05 | 0.05 | 0.05 | 0.05 | 0.05 | 0.05 | 0.008 | 0.05 |
| Preservative | 75 | 75 | 75 | 75 | 75 | 75 | 75 | 75 | 75 |
| (ppm)^{j} | | | | | | | | | |
| Antifoam^{k} | 0.005 | 0.005 | 0.005 | 0.005 | 0.005 | 0.005 | 0.005 | 0.014 | 0.005 |
| Dye (ppm) | 40 | 65 | 75 | 65 | 65 | 50 | 50 | 30 | 65 |
| HCl | 0.020 | 0.010 | 0.010 | 0.02 | 0.02 | 0.01 | 0.02 | 0.010 | 0.02 |
| Formic | 0.025 | 0.025 | 0.025 | 0.025 | 0.025 | — | — | — | 0.025 |
| Acid | | | | | | | | | |
| Deionized | Balance | Balance | Balance | Balance | Balance | Balance | Balance | Balance | Balance |
| Water | | | | | | | | | |

^{a}Fabric Softening Active from the reaction product of Example I.
^{b}Fabric Softening Active from the reaction product of Example II.
^{c}Fabric Softening Active from the reaction product of Example III.
^{d}Fabric Softening Active from the reaction product of Example IV.
^{e}Fabric Softening Active from the reaction product of Example V.
^{f}Cationic high amylose maize starch available from National Starch under the trade name HYLON VII ®.
^{g}Rheovis CDE ex Ciba.
^{h}Perfume microcapsules available ex Appleton
ⁱDiethylenetriaminepentaacetic acid.
^{j}Korelone B-119 (1,2-benzisothiazolin-3-one) available from Rohm and Haas. “PPM” is “parts per million.”
^{k}Silicone antifoam agent available from Dow Corning Corp. under the trade name DC2310 or Silicone MP10.

### Example XV

### Through the Rinse Performance of Example VI and XII Compared to DEEDMAMS

Representative fabrics (100% cotton EuroTouch terry towels obtained from Standard Textile, 2250 Progress Dr., Hebron, Ky.) are washed using a Kenmore 80 series, medium fill, 17 gallon, top-loading washing machine using Ace powdered detergent on the heavy duty cycle (90° F. Wash/60° F. Rinse). The liquid fabric softener control that is made using 5% DEEDMAMS and the fabric softener made from Example VI and XII and are added into the final rinse cycle. The amount of fabric softener added to the washer is normalized to deliver an equivalent amount of fabric softening active to the washing machine. Fabrics are dried using a Kenmore series dryer on the cotton/high setting for 50 min. The treated fabrics are compared and the difference in softness relative to a no treatment in the rinse control is judged by expert graders. Results are expressed using the standard Panel Score Unit scale: +4 psu (very large difference in favor of TEST product) to −4 psu (very large difference in favor of CONTROL product). There is no difference between the fresh 5% DEEDMAMS and the fresh Example XII (PSU=2.9), and a 0.1 PSU decrease in 12 w/50° C. aged samples of Example XII and Example VI (PSU=2.8) where a score of 1 PSU is judged as “I think there might be a difference.”

### Methods

Quantitative HPLC. High pressure liquid chromatography with evaporative light scattering detection (Waters Alliance 2695 HPLC and Waters 2420 ELSD) is used for the quantitative analysis of monoester quat (MEQ), diester quat (DEQ), free fatty acid (FFA), and diester amine (DEA) species in the ester quat raw materials and in aqueous dispersions. Sample solutions for analysis are prepared by dissolving a known amount of the sample in a 50:50 chloroform/methanol solution and then diluting the mixture in an equal volume of methanol to give a target ester quat target concentration of approximately 1 mg/mL. Separation of all species is achieved by injection of 10 mL aliquot of the sample solution on an RP18 column (4.6×150 mm, 3.5 micron, Waters XBridge P/N 186003045) and elution with a mobile phase of water and methanol that is buffered with 10 mM ammonium acetate and 0.1% glacial acetic acid at a flow rate of 1.5 mL/min. The mobile phase gradient is ramped from 80% methanol to 100% methanol over 10 minutes with a hold time of 5 minutes at 100% methanol. These conditions allow the desired resolution and complete elution of all analytes of interest in 15 minutes. Peaks on the ELSD chromatograms corresponding to MEQ, DEQ, FFA, and DEA species are integrated and quantified using log-log external standard calibration curves over a range of approximately 10-2000 ppm. Pure monostearate and distearate quat materials that have been purified using column chromatography are used as standards to prepare the calibration curve for MEQ, DEQ, and DEA species; stearic acid (Fluka, catalog number 85679) is used as a standard for quantitation of all FFA species in the sample.

Dispersion Procedure. The quat materials are heated in an oven in a covered jar at 90° C. until they are completely melted. The melted quat is added to water containing 0.02-0.05% by weight aqueous HCl solution that is pre-heated to 70° C. while mixing using an IKA T25 Basic Mixter operated at 8000-13,500 rpm. If the dispersion contains >10% Quat, 500-2500 ppm CaCl₂ is added from an aqueous solution that is 2-25% by weight CaCl₂. Dispersions are mixed for an additional 2-5 min with the IKA mixer at 8000-13,500 rpm and the pH may be adjusted with 35% by weight HCl or 50% by weight NaOH as needed. Dispersions are cooled in an ice bath with stifling to 30° C. Dispersions are optionally finished with perfume, thickener, and other adjunct ingredients according to the examples above.

Rapid Aging Procedure. Dispersions are aged in heating blocks (J-KEM Scientific, Model #: DTC-6) containing space for heating eleven scintillation vials. Each block is calibrated using traceable Robo Thermometers from Control Company (Model #23609-204). One thermometer for each temperature is placed in a separate scintillation vial filled with 100% glycerin (Sigma, batch#087K02371). Dispersions (10 g) are added to scintillation vials (Wheaton, product #986546), and are placed in the heating blocks, one vial per temperature. The vials used for room temperature are placed on a lab benchtop for the duration of the test. All vials are heated, undisturbed, for two weeks in heating blocks that are calibrated to 32° C., 36° C., 40° C., 44° C., 48° C., 52° C., 56° C., 60° C., 64° C., 68° C., 72° C. and 75° C. HPLC analysis is performed on each treatment to determine the relative amounts of diester quat, monoester quat, diester amine, and fatty acid present and is reported as a relative percentage. HPLC analysis is performed only on dispersions heated to room temperature, 36° C., 48° C., 52° C., 60° C. and 64° C.

Fatty Acid Titration. Hydrolytic stability is determined for aqueous dispersions of the fabric softener active compositions that were stored at 50° C. in closed glass bottles. Acid values of the dispersions were determined before and after storage by acid-base-titration with KOH or NaOH and are given as mg KOH/g dispersion.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fabric softener composition comprising from 1% to 49% of a fabric softener active comprising a compound of formula (I): 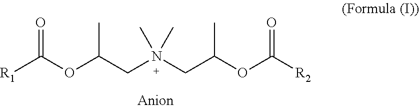
wherein R₁ and R₂ is each independently a C₁₅-C₁₇, and wherein the C₁₅-C₁₇ is unsaturated or saturated, branched or linear, substituted or unsubstituted.

2. The composition of claim 1, wherein the anion is (CH₃O)SO₃⁻; and wherein the R₁ and R₂ is each linear and unsubstituted.

3. The composition of claim 2, wherein each R₁ and R₂ has an average chain length C₁₅ to C₁₇ each (preferably 16.5 to 17.8 carbon atoms).

4. The composition of claim 3, wherein the Iodine Value comprises from 15-50.

5. The composition of claim 1, further comprising from 0.1% to 25% of the composition of a compound of formula (II) 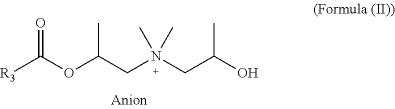
wherein R₃ is a C₁₅-C₁₇, wherein the C₁₅-C₁₇ is unsaturated or saturated, branched or linear, substituted or unsubstituted, and wherein the Iodine Value (IV) is from about 0.5 to 60.

6. The composition of claim 5, wherein the anion of formula (II) compound is (CH₃O)SO₃⁻ and R₃ has an average chain length from 16.5 to 17.8 carbon atoms and has an IV from 15 to 50.

7. The composition of claim 6, wherein cis:trans ratio of double bonds of unsaturated fatty acid moieties of the formula (I) compound is from 1.3:1 to 3.1:1, respectively.

8. The composition of claim 4, further comprising from 0.1% to 25% of the composition of a compound of formula (II) 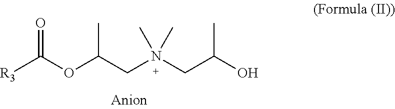
R₃ has an average chain length from 16.5 to 17.8 carbon atoms, has an IV from 15 to 50. the anion of formula (II) compound is (CH₃O)SO3⁻, and wherein the cis: trans ratio of double bonds of unsaturated fatty acid moieties of the formula (I) compound is from 1.3:1 to 3.1:1.

9. The composition of claim 8, wherein the compound of formula (I) has a melt transition temperature below 55° C. as determined by a differential scanning calorimetry (DSC) method.

10. The composition of claim 9, wherein the composition further comprises a perfume.

11. The composition of claim 10, wherein the perfume further comprises a friable perfume microcapsule.

12. The composition of claim 11, wherein the composition comprises less than 5% by weight of the composition of solvent, wherein the solvent is chosen from: ethanol, propanol, isopropanol, n-propanol, n-butanol, t-butanol, glycerol, ethylene glycol, trimethylene glycol, tetramethylene glycol, pentamethylene glycol, hexamethylene glycol, diethylene glycol, triethylene glycol, propylene glycol, dipropylene glycol and C₁-C₄ alkyl monoethers of ethylene glycol, propylene glycol, and dipropylene glycol, sorbitol, alkane diols such as 1,2 propanediol, 1,3 propanediol, 2,3-butanediol, 1,4-butanediol, 1,3-butanediol, 1,5-pentanediol, and 1,6 hexanediol; phenylethyl alcohol, 2-methyl 1,3-propanediol, hexylene glycol, sorbitol, polyethylene glycols, 1,2-hexanediol, 1,2-pentanediol, 1,2-butanediol, 1,4-cyclohexanedimethanol, pinacol, 2,4-dimethyl-2,4-pentanediol, 2,2,4-trimethyl-1,3-pentanediol (and ethoxylates), 2-ethyl-1,3-hexanediol, phenoxyethanol (and ethoxylates), glycol ethers, butyl carbitol, dipropylene glycol n-butyl ether, or combinations thereof, by weight of the composition.

13. The composition of claim 12, wherein the composition comprises from 0.015% to 1% of a fatty acid triglyceride having an average chain length of the fatty acid moieties of from 10 to 14 carbon atoms and an IV calculated for the free fatty acid, of from 0 to 15 by weight of the composition.

14. The composition of claim 11, wherein the composition further comprises from 0.1% to 5% by weight of a cationic cross-linked polymer that is from the polymerization of from 5 to 100 mole present of cationic vinyl addition monomer, from 0 to 95 mole percent of acrylamide, and from 50 to 1000 parts per million (ppm) of a vinyl addition monomer cross-linking agent.

15. A method of softening laundry comprising the step of administering a composition of claim 1, to a rinse cycle of an automatic laundry machine or a hand washing laundry rinse basin.
